(19) United States
(12) Patent Application Publication
(10) Pub. No.: US 2023/0334962 A1
(43) Pub. Date: Oct. 19, 2023

(54) DRAWER CONTROL APPARATUS, DRAWER CONTROL METHOD, AND DRAWER CONTROL SYSTEM

(71) Applicant: STAR MICRONICS CO., LTD., SHIZUOKA (JP)

(72) Inventors: RINA MAKITA, SHIZUOKA (JP); YUICHI SUGIYAMA, SHIZUOKA (JP)

(21) Appl. No.: 18/339,793

(22) Filed: Jun. 22, 2023

Related U.S. Application Data
(63) Continuation of application No. PCT/JP2021/044006, filed on Dec. 1, 2021.

(30) Foreign Application Priority Data
Dec. 28, 2020 (JP) 2020-218330

(51) Int. Cl. G07G 1/00; G07G 1/12

(52) U.S. Cl. CPC G07G 1/0027; G07G 1/12

(57) ABSTRACT

A drawer control apparatus capable of precisely discriminating whether the drawer open state is triggered by the drawer open command process or otherwise. The drawer control apparatus includes a command receiving unit, a drawer connection detecting unit, a command processing unit, a drawer open/closed signal receiving unit, and an open trigger discriminating unit. The command processing unit executes a drawer open command process upon receiving a drawer open command. The drawer open command process includes sending a drawer open signal and setting a process execution flag upon detecting presence of drawer connection. The drawer open command process ends upon detecting absence of drawer connection. The open trigger discriminating unit discriminates whether the drawer open state is triggered by the drawer open command process or otherwise according to a set state of the process execution flag upon receiving a signal representing the drawer open state.

### TECHNICAL FIELD

The present invention relates to a drawer control apparatus, a drawer control method, and a drawer control system.

### BACKGROUD ART

In a POS system or a cach register, a drawer apparatus such as a cash drawer is used to save coins, bills, and money coupons. Such drawer is controlled by a drawer control apparatus or a drawer control system provided with a host terminal. The drawer control apparatus can be used independently or can be incorporated in a peripheral equipment of the POS system. Upon receiving a drawer open command from the host terminal, the drawer control apparatus executes a drawer open command process to send a drawer open signal to allow access to the money tray. Opening the drawer by the drawer open signal is usual in the POS system or the cash register. Opening the drawer by means other than the signal or manually opening the drawer with a key or something might have the possibility of a theft or a crime. The drawer control system includes means for discriminating whether the drawer open state is triggered by the drawer open command or otherwise (See Patent Document 1). The drawer control system disclosed in Document 1 starts the drawer open command process in response to the drawer open command. The drawer control system sets the open start flag to open the drawer and clears the open start flag to close the drawer. The drawer control system detects a state of the drawer at certain intervals and check the open start flag upon detecting the drawer is open. When the open start flag is found to be cleared, the drawer control system will discriminate that the drawer open state is triggered by means other than the drawer open command process.

### PRIOR ART DOCUMENT

### Patent Document

Patent Document 1: Japanese Patent Application Publication No.H10-143761

### TECHNICAL PROBLEM

Upon receiving the drawer open command, the drawer control system disclosed in Document 1 will start the drawer open command process regardless of presence or absence of drawer connection. The drawer control system will set the open start flag and keep the flag set until the drawer is first opened and then closed. The flag will be kept set while the drawer is not connected to the drawer control apparatus. Then, when the drawer in the closed state is connected to the drawer control aparatus and then changed to the open state by means other than the drawer open command process, the drawer control system will wrongly discriminate that the drawer open command process triggers the open state since the flag has been set. The conventional drawer control system has a problem of deteriorated discrimination accuracy.

The present invention provides a drawer control apparatus, a drawer control method, and a drawer control system capable of accurately discriminating whether the open state of the drawer is triggered by the drawer open command process or otherwise.

### TECHNICAL SOLUTION

The drawer control apparatus of the invention includes a command receiving unit capable of receiving a command from a host terminal; a drawer connection detecting unit capable of detecting presence or absence of connection of a drawer; a command processing unit capable of executing a drawer open command process when the command receiving unit receives a drawer open command, the drawer open command process comprising sending a drawer open signal and setting a process execution flag when the drawer connection detecting unit detects the presence of connection of the drawer, and the drawer open command process further comprising terminating the drawer open command process when the drawer connection detecting unit detects the absence of connection of the drawer; a drawer open/closed signal receiving unit capable of receiving a drawer open/closed signal from the drawer, the signal representing a drawer open state or a drawer closed state; and an open trigger discriminating unit capable of discriminating whether the drawer open state is triggered by the drawer open command process or otherwise according to a set state of the process execution flag when the drawer open/closed signal receiving unit receives the signal representing the drawer open state.

The drawer control apparatus can start the drawer open command process in response to the drawer open command. When the drawer connection detecting unit detects that the drawer is not connected, the drawer control apparatus can terminate the process without setting the process execution flag. When the drawer in the closed state is connected and then changed to the open state, the trigger discriminating unit can accurately discriminate whether the drawer open state is triggered by the drawer open command process or otherwise.

The trigger discriminating unit can discriminate whether the drawer open state is triggered by the drawer open command process or otherwise according to a set state of the process execution flag when the signal received by the drawer open/closed signal receiving unit represents the change from the drawer closed state to the drawer open state.

The drawer control apparatus further includes a flag clearing unit capable of clearing the process execution flag after predetermined time elapses since the flag was set.

When the drawer is not opened for some reason in response to the drawer open command, the process execution flag can be cleard after predetermined time elapses. When the drawer is then opened by means other than the drawer open command process, the drawer control system can accurately discriminate the trigger for the drawer open state.

The flag clearing unit can clear the process execution flag when the drawer connection detecting unit detects that the drawer is not connected. The flag clearing unit can clear the flag when the signal received by the drawer open/closed signal receiving unit represents the change from the drawer open state to the drawer closed state.

The drawer control apparatus further includes a state information transmitting unit capable of transmitting drawer connection information to the host terminal. The drawer connection information represents the presence or absence of connection of the drawer.

The host terminal can analyze the state of the drawer according to the drawer connection information.

The state information transmitting unit further transmits drawer open/closed information and open trigger information to the host terminal. The drawer open/closed information represents the drawer open state or the drawer closed state. The open trigger information represents a discrimination result of the open trigger discriminating unit.

The host terminal can further analyze the state of the drawer according to the drawer open/closed information and the open trigger information.

The state information transmitting unit can transmit the drawer connection information, the drawer open/closed information and the open trigger information to the host terminal when the command receiving unit receives a status inquiry command.

The drawer control apparatus further includes a drawer state storing unit capable of storing drawer connection information representing the presence or absence of connection of the drawer, drawer open/closed information representing the drawer open state or the drawer closed state, and open trigger information representing a discrimination result of the open trigger discriminating unit; a state monitoring unit capable of monitoring a change in the drawer connection information and a change in the drawer open/closed information; and a state information transmitting unit capable of transmitting the drawer connection information, the drawer open/closed information, and the open trigger information stored in the drawer state storing unit to the host terminal when the state monitoring unit detects a change in at least one of the drawer connection information and the drawer open/closed information.

The host terminal can immediately acquire the drawer connection information, the drawer open/closed information and the open trigger information when there happens a change in the drawer connection information or in the drawer open/closed information. The host terminal can accurately recognize a change in the state of the drawer.

The drawer control apparatus includes a drawer connection detecting unit capable of detecting presence or absence of connection of a drawer; and a state information transmitting unit capable of transmitting drawer connection information to the host terminal. The drawer connection information represents the presence or absence of connection of the drawer.

The host terminal can analyze the state of the drawer according to the drawer connection information.

The drawer control method includes receiving a command from a host terminal; detecting presence or absence of connection of a drawer; executing a drawer open command process upon receiving a drawer open command, the drawer open command process comprising sending a drawer open signal and setting a process execution flag upon detecting the presence of connection of the drawer, and the drawer open command process further comprising terminating the drawer open command process upon detecting the absence of connection of the drawer; receiving a signal from the drawer, the signal representing a drawer open state or a drawer closed state; and discriminating whether the drawer open state is triggered by the drawer open command process or otherwise according to a set state of the process execution flag upon receiving the signal representing the drawer open state.

When the drawer is not connected, the drawer open command process will be terminated without setting the process execution flag, which allows an accurate discrimination about whether the drawer open state is triggered by the drawer open command process or otherwise.

The descriminating step can be executed upon detecting a change in the received signal from the drawer closed state to the drawer open state.

A drawer control system includes a host terminal and a drawer control apparatus. The drawer control apparatus includes a command receiving unit capable of receiving a command from a host terminal; a drawer connection detecting unit capable of detecting presence or absence of connection of a drawer; a command processing unit capable of executing a drawer open command process when the command receiving unit receives a drawer open command, the drawer open command process comprising sending a drawer open signal and setting a process execution flag when the drawer connection detecting unit detects the presence of connection of the drawer, and the drawer open command process further comprising terminating the drawer open command process when the drawer connection detecting unit detects the absence of connection of the drawer; a drawer open/closed signal receiving unit capable of receiving a drawer open/closed signal from the drawer, the signal representing a drawer open state or a drawer closed state by a signal level; a trigger discriminating unit capable of discriminating whether a change in the drawer open state and the drawer closed state is triggered by the drawer open command process or otherwise according to a set state of the process execution flag when the drawer open/closed signal receiving unit receives the signal representing the change in the drawer open state and the drawer closed state; and a state information transmitting unit capable of transmitting information to the host terminal, the information including information representing a discrimination result by the trigger discriminating unit and information representing the signal level. The host terminal includes a discriminating unit capable of discriminating whether the drawer open state is triggered by the drawer open command process or otherwise according to the information transmitted from the state information transmitting unit.

The drawer control apparatus can start the drawer open command process in response to the drawer open command. When the drawer connection detecting unit detects that the drawer is not connected, the drawer control apparatus can terminate the process without setting the process execution flag. When the drawer in the closed state is connected and then changed to the open state, the discriminating unit can accurately discriminate whether the drawer open state is triggered by the drawer open command process or otherwise.

The present invention provides a drawer control apparatus, a drawer control method, and a drawer control system capable of accurately discriminating whether the open state of the drawer is triggered by the drawer open command process or otherwise.

### BRIEF DESCRIPTION OF THE DRAWINGS

FIG. 1 is a block diagram showing a hardware configuration of a drawer control apparatus corresponding an embodiment of the invention.

FIG. 2 is a block diagram showing a functional configuration of the drawer control apparatus shown in FIG. 1.

FIG. 3 is a circuit diagram showing how a drawer open signal operates and how a connection signal is generated.

FIG. 4 is a flowchart showing an operation of the drawer control apparatus.

FIG. 5 is a flowchart of a drawer state information acquiring process shown in FIG. 4.

FIG. 6 is a flowchart of a drawer open command process shown in FIG. 4.

FIG. 7 is a flowchart of a drawer status notifying process shown in FIG. 4.

FIG. 8 is a timing chart showing a normal operation of the drawer control apparatus shown in FIG. 1.

FIG. 9 is a timing chart showing operations before and after a drawer is connected in the drawer control apparatus shown in FIG. 1.

FIG. 10 is a flowchart of the drawer state information acquiring process in a drawer control apparatus 1 of a second embodiment.

FIG. 11 is a flowchart of the drawer status notifying process in the drawer control apparatus 1 of the second embodiment.

FIG. 12 is a block diagram showing a functional configuration of the drawer control apparatus 1 of a third embodiment.

FIG. 13 is a flowchart of the drawer state information acquiring process in the drawer control apparatus 1 of the third embodiment.

FIG. 14 is a flowchart of the drawer status notifying process in the drawer control apparatus 1 of the third embodiment.

### MODE FOR INVENTION

Hereinafter, an embodiment of the present invention will be described. A drawer control apparatus of an embodiment of the invention may be connected to a host terminal of a POS system and a drawer respectively to control the drawer in accordance with a command from the host terminal.

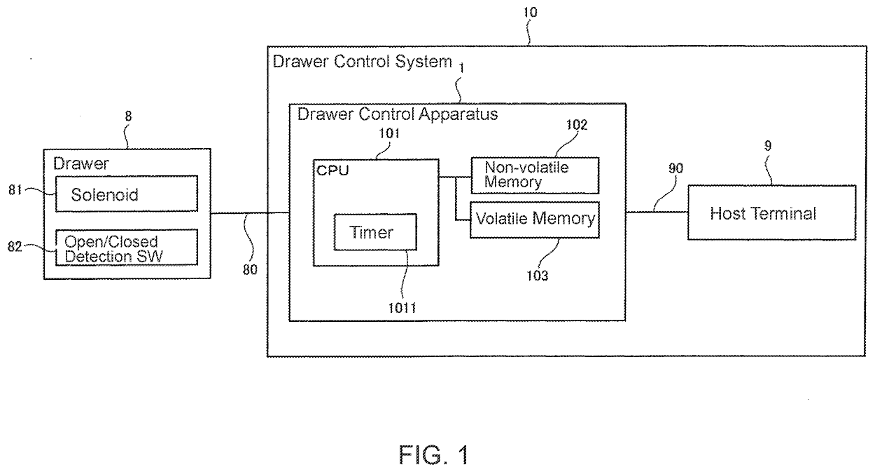

FIG. 1 is a block diagram showing a hardware configuration of the drawer control apparatus corresponding the embodiment of the invention.

The drawer control apparatus 1 may be connected to a drawer 8 via a drawer interface 80. The drawer control apparatus 1 may be connected to a host terminal 9 via a host interface cable 90. The drawer control apparatus 1, the host terminal 9, and the host interface cable 90 may constitute a drawer control system 10. The drawer interface 80 may be detachably attached to the drawer control apparatus 1 and the drawer 8 respectively. Removing the drawer interface 80 may separate the drawer 8 from the drawer control apparatus 1. Absence of connection of the drawer 8 may be referred to as a drawer non-connected state. Presence of connection of the drawer 8 may be referred to as a drawer connected state. Removing the host interface cable 90 may separate the drawer control apparatus 1 from the host terminal 9. The drawer control apparatus 1 and the host terminal 9 may be wirelessly connected. The drawer control apparatus 1 and the drawer 8 may be wirelessly connected when they are respectively provided with a power supply. The host terminal 9 may desirably include a device provided with an input and a display such as a tablet terminal and a personal computer.

The drawer 8 may be provided with a solenoid 81 and an open/closed detection switch 82. The solenoid 81 may be electrically driven to push a money tray and thereby bring the drawer 8 into the open state. The open/closed detection switch 82 may detect whether the drawer 8 is in the open state or in the closed state. The detection result may be transmitted to the drawer control apparatus 1 via the drawer interface 80. The detection result may be in a form of a signal representing the drawer open state or the drawer closed state.

The host terminal 9 may transmit a command to the drawer control apparatus 1 via the host interface cable 90. The command may include a drawer open command and a status inquiry command. The host terminal 9 may receive a status information stored in the drawer control apparatus 1 via the host interface cable 90 as described below.

The drawer control apparatus 1 may include a CPU (Central Processing Unit) 101, a non-volatile memory 102, and a volatile memory 103. The CPU 101 may control the operation of the drawer control apparatus 1 in accordance with a program stored in the non-volatile memory 102. The CPU 101 may exchange signals with the drawer 8 via the drawer interface 80 and exchange data with the host terminal 9 via the host interface cable 90. The CPU 101 may be provided with a timer 1011. The non-volatile memory 102 may include a ROM (Read Only Memory) capable of storing the program. The volatile memory 103 may include a RAM (Random Access Memory) capable of storing data available by the drawer control apparatus 1. The non-volatile memory 102 and the volatile memory 103 may be incorporated in the CPU 101.

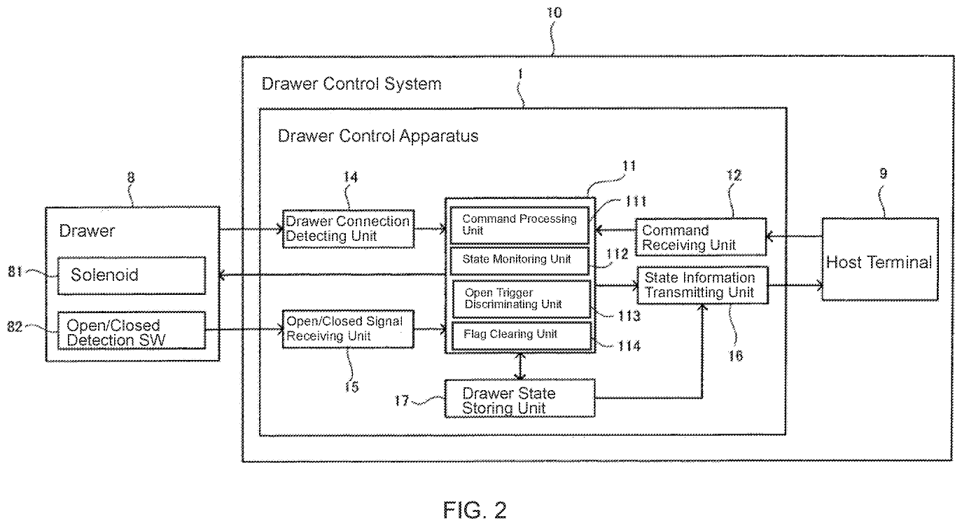

FIG. 2 is a block diagram showing a functional configuration of the drawer control apparatus shown in FIG. 1.

The drawer control apparatus 1 may include a control unit 11, a command receiving unit 12, a drawer connection detecting unit 14, a drawer open/closed signal receiving unit 15, a state information transmitting unit 16, and a drawer state storing unit 17. The CPU 101 may operate those functional units by using the volatile memory 103 in accordance with a program stored in the non-volatile memory 102.

The command receiving unit 12 may receive various commands from the host terminal 9 and transmit any received command to the control unit 11. The drawer connection detecting unit 14 may receive a connection signal representing whether the drawer 8 is connected to the drawer control apparatus 1. The drawer open/closed signal receiving unit 15 may receive a signal detected by the open/closed detecting switch 82, the signal representing the open state or the closed state of the drawer 8. The open/closed signal may have different output levels depending on the open state or the closed state of the drawer 8. The open/closed detecting switch 82 may transmit a signal of High level upon detecting the drawer open state and a signal of Low level upon detecting the drawer closed state. The signal may be of reverse levels depending on a type of the drawer 8. The drawer control apparatus 1 may be provided with a DIP switch or a memory switch to exchange the open and closed states of the drawer 8 corresponding to the High and Low output levels transmitted from the open/closed detecting switch 82. The state information transmitting unit 16 may transmit internal status information stored in the drawer state storing unit 17 to the host terminal 9. The drawer state storing unit 17 may store at least drawer connection information representing presence or absence of connection of the drawer 8, drawer open-closed information representing the drawer open state or the drawer closed state acquired from the signal received by the drawer open/closed signal receiving unit 15, and drawer open trigger information representing a discrimination result by an open trigger discriminating unit 113 described below. The internal status information stored in the drawer state storing unit 17 or the volatile memory 103 may be erased when the drawer control apparatus 1 is powered off.

The control unit 11 may include a command processing unit 111, a state monitoring unit 112, the open trigger discriminating unit 113, and a flag clearing unit 114. The command processing unit 111 may execute an operation depending on a command received by the command receiving unit 12. The command may include a drawer open command and a status inquiry command, which are being described in detail. The state monitoring unit 112 may monitor the drawer connection information and the drawer open/closed information. When the state monitoring unit 112 detects a change in at least one of the drawer connection information and the drawer open/closed information, the state information transmitting unit 16 may transmit the internal status information stored in the drawer state storing unit 17 to the host terminal 9. When the signal received by the drawer open/closed signal receiving unit 15 represents a change from the drawer closed state to the drawer open state, the open trigger discriminating unit 113 may discriminate whether the drawer open state is triggered by the drawer open command or otherwise according to a set state of a process execution flag described below. The command processing unit 111 may execute a drawer open command process in response to the drawer open command and set the process execution flag when certain conditions are satisfied. The flag clearing unit 114 may clear the process execution flag when certain period of time elapses since the flag was set. The flag clearing unit 114 may also clear the flag when the drawer is not connected or when the signal received by the drawer open/closed signal receiving unit 15 represents a change from the drawer open state to the drawer closed state. The process execution flag set in the volatile memory 103 may be erased when the drawer control apparatus 1 is powered off.

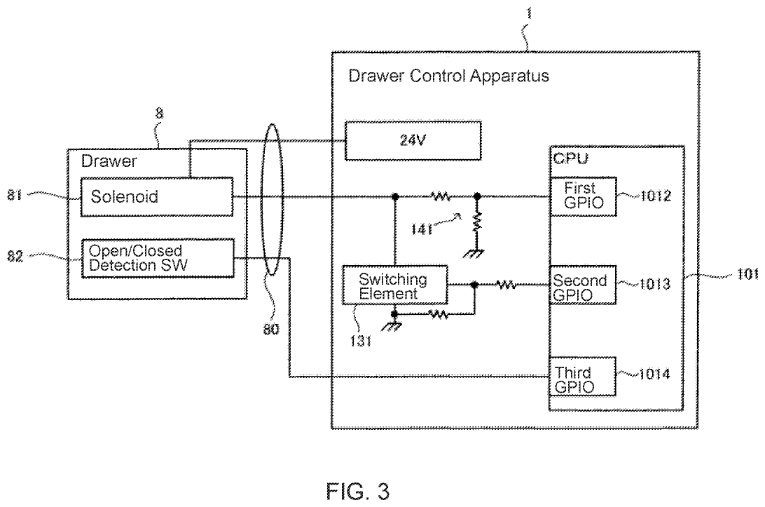

FIG. 3 is a circuit diagram showing how the drawer open signal operates and how the connection signal is generated. FIG. 3 shows the open/closed detection switch 82 and a third GPIO (General-Purpose Input/Output) 1014 capable of receiving the signal from the open/closed detection switch 82. FIG. 3 also shows an input/output line to/from the solenoid 81 and a receiving line for the signal from the open/closed detection switch 82 respectively provided in the drawer interface 80.

The drawer control apparatus 1 may supply 24V power to the solenoid 81 of the connected drawer 8. When the drawer open signal is transmitted via a second GPIO 1013 provided in the CPU 101, a switching element 131 constituted by an FET (Field Effect Transistor) or a transistor may turn on to generate a flow of drive current through the solenoid 81. The solenoid 81 may be thereby driven to push the money tray forward to bring the drawer 8 into the open state. The drawer open signal may be transmitted via the second GPIO 1013 only when certain conditions are satisfied. The connection signal of the drawer 8 may be generated by a division circuit 141 from the 24V power supplied to the solenoid 81. When the drawer 8 is not connected, a connection signal of OV may be input to a first GPIO 1012. When the drawer 8 is connected, a connection signal of 3.3V may be input to the first GPIO 1012. The drawer connection detecting unit 14 may receive the connection signal to detect presence or absence of the drawer 8. Detection by the drawer connection detecting unit 14 may be an example of a drawer connection detecting step.

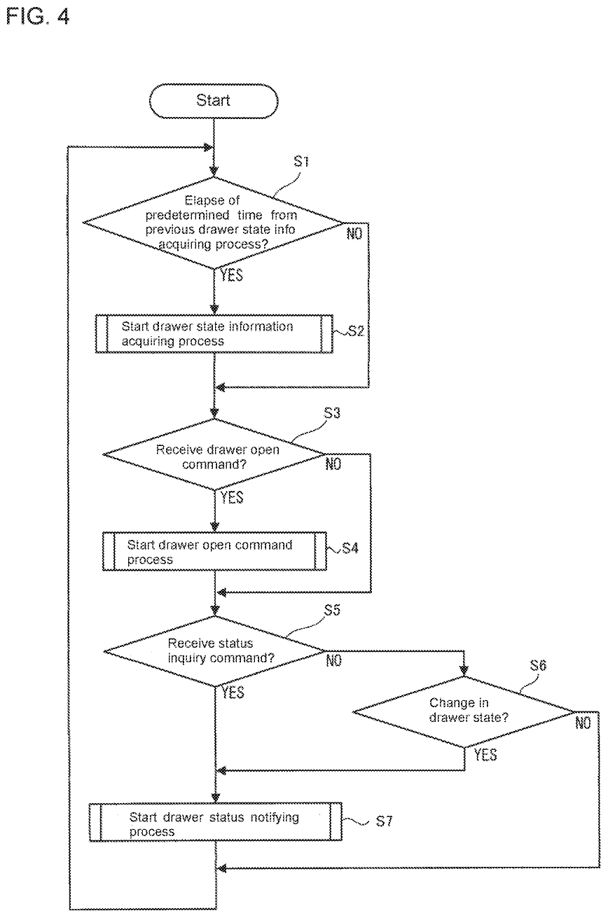

An operation of the drawer control apparatus 1 is being described. FIG. 4 is a flowchart showing the operation of the drawer control apparatus shown in FIG. 1.

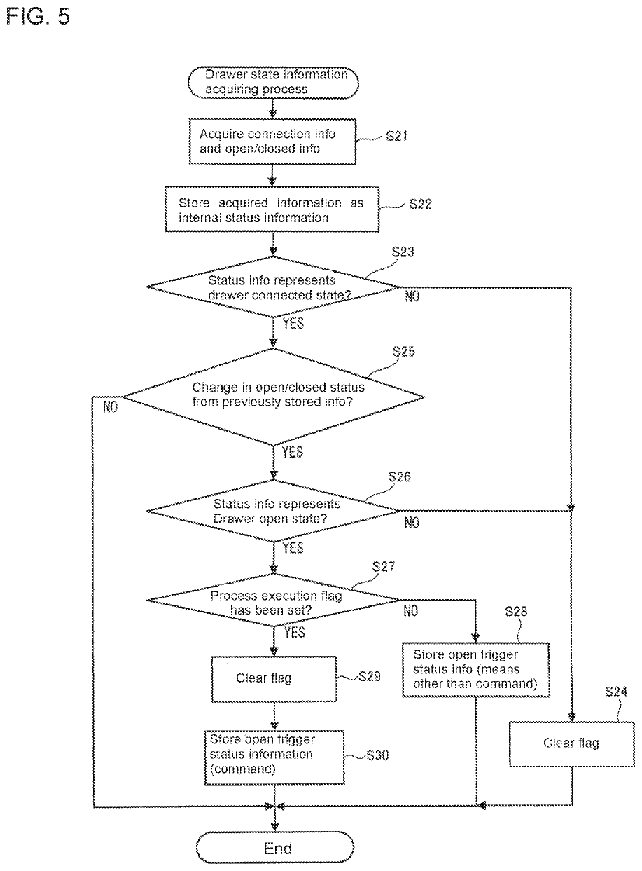

The drawer control apparatus 1 may periodically execute a drawer state information acquiring process shown in FIG. 5. First, the drawer control apparatus 1 may determine whether a predetermined time has elapsed since the previous drawer state information acquiring process (Step S1) with the timer 1011 starting measuring time at the start of the drawer state information acquiring process. The drawer control apparatus 1 may determine that this is the first drawer state information acquiring process by recognizing that the drawer state storing unit 17 has no internal status information or that the timer 1011 has not started. The drawer control apparatus 1 may determine that the predetermined time has elapsed also at power on or upon determining that this is the first drawer state information acquiring process. The predetermined time may be set to twenty (20) msec in this embodiment. In the event that the predetermined time has elapsed (YES in S1), the drawer control apparatus 1 may start the drawer state information acquiring process shown in FIG. 5 and then proceed to Step S3. In the event that the predetermined time has not elapsed (NO in S1), the drawer control apparatus 1 may immediately proceed to Step S3.

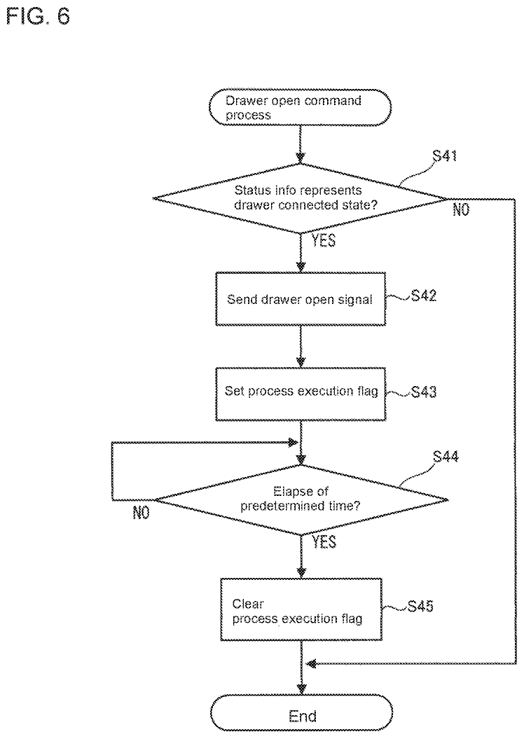

In Step S3, the drawer control apparatus 1 may determine whether the command receiving unit 12 has received the drawer open command. In the event that the drawer open command is received (YES in S3), the drawer control apparatus 1 may start the drawer open command process shown in FIG. 6 (Step S4) and then proceed to Step S5. Receiving the drawer open command may be an example of a command receiving step. In the event that the drawer open command is not received (NO in S3), the drawer control apparatus 1 may immediately proceed to S5.

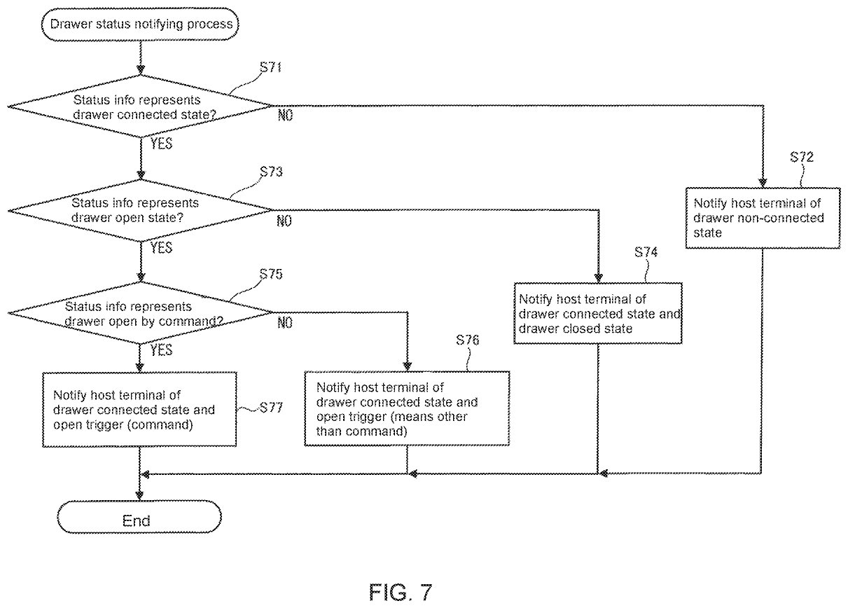

In Step S5, the drawer control apparatus 1 may determine whether the command receiving unit 12 has received the status inquiry command. In the event that the status inquiry command is received (YES in S5), the drawer control apparatus 1 may start the drawer status notifying process shown in FIG. 7 (Step S7) and then return to Step 51. In the event that the status inquiry command is not received (NO in S5), the drawer control apparatus 1 may determine whether the state monitoring unit 112 has detected a change in the state of the drawer 8 (Step S6). The state monitoring unit 112 may detect the change in the state of the drawer 8 by detecting a change in the drawer connection information or a change in the drawer open/closed information. Specifically, in the drawer state information acquiring process described below, the state monitoring unit 112 may determine that the state of the drawer 8 has changed when at least one of the drawer connection information and the drawer open/closed information just stored is different from the previous status information stored in the drawer state storing unit 17. In the event that the state monitoring unit 112 detects a change in the state of the drawer 8 (YES in S6), the drawer control apparatus 1 may start the drawer status notifying process shown in FIG. 7 (Step S7) and then return to Step S1. In the event that the state monitoring unit 112 detects no change in the state of the drawer 8 (NO in S6), the drawer control apparatus 1 may immediately return to Step S1. The drawer control apparatus 1 may repeat the operations until power off.

FIG. 5 is a flowchart of the drawer state information acquiring process shown in FIG. 4.

First, the drawer connection detecting unit 14 may detect presence or absence of connection of the drawer 8 to obtain the drawer connection information and the drawer open/closed signal receiving unit 15 may receive the signal to obtain the drawer open/closed information (Step S21). This may be an example of a drawer open/closed signal receiving step. The drawer control apparatus 1 may store the obtained information in the drawer state storing unit 17 as current internal status information (Step S22) while keeping the previously stored information as the previous internal status information, including the drawer connection information, the drawer open/closed information, and the open trigger information.

Then, the drawer control apparatus 1 may determine whether the drawer connection status information just stored represents that the drawer is connected (Step S23). In the event that the drawer connection status information represents absence of connection (NO in S23), the flag clearing unit 14 may clear the process execution flag (Step S24) and then the drawer state information acquiring process may end. In the event that the process execution flag has been cleared, the drawer state information acquiring process may immediately end. In the event that the drawer connection status information represents presence of connection (YES in S23), the drawer control apparatus 1 may compare the previous open/closed status information with the current open/closed status information to determine whether a change happens (Step S25). The drawer control apparatus 1 may determine that no change happens when the drawer state storing unit 17 stores no previous information, for example, at the first process immediately after power on. In the event that no change happens in the drawer open/closed status information (NO in S25), the drawer state information acquiring process may end. In the event that a change happens in the drawer open/closed status information (YES in S25), the drawer control apparatus 1 may determine whether the current status information represents the drawer open state (Step S26). In the event that the current drawer open/closed status information represents the closed state (NO in S26), the drawer control apparatus 1 may proceed to Step S24 and then terminate the drawer state information acquiring process.

In the event that the current drawer open/closed status information represents the open state (YES in S26), the drawer control apparatus 1 may determine whether the process execution flag has been set (Step S27). In the event that the process execution flag has been cleared (NO in S27), the drawer control apparatus 1 may store a current open trigger status information in the drawer state storing unit 17 (Step S28), the information representing that the drawer open state was triggered by means other than the drawer open command process, and then terminate the drawer state information acquiring process. In the event that the process execution flag has been set (YES in S27), the drawer control apparatus 1 may clear the process execution flag (Step S29), store a current open trigger status information in the drawer state storing unit 17 (Step S30), the information representing that the drawer open state was triggered by the drawer open command process, and then terminate the drawer state information acquiring process. The S27 to S30 steps may correspond to an open trigger discriminating step, which may be executed by the open trigger discriminating unit 113.

FIG. 6 is a flowchart of the drawer open command process shown in FIG. 4.

First, the drawer control apparatus 1 may determine whether the latest drawer connection status information stored in the drawer state storing unit 17 represents the presence of connection (Step S41). In the event that the drawer connection status information represents the absence of connection (NO in S41), the drawer control apparatus 1 may terminate the drawer open command process. In the event that the drawer connection status information represents the presence of connection (YES in S41), the drawer control apparatus 1 may send the drawer open signal (Step S42) and set the process execution flag (Step S43). The S41 to S43 steps may correspond to a drawer open command process, which may be executed by the command processing unit 111. The drawer control apparatus 1 may be kept standby until an elapse of predetermined time, which may be measured by the timer 1011 starting upon setting the process execution flag. The predetermined time may be long enough for sending the drawer open signal in Step S42, opening the drawer 8 by the solenoid 81, detecting the drawer open state by the open/closed detection switch 82, and sending the drawer open signal. The predetermined time may be set to 2.0 sec in this embodiment. In the event that the predetermined time has elapsed (YES in S44), the drawer control apparatus 1 may clear the process execution flag and then terminate the drawer open command process. The drawer control apparatus 1 may immediately terminate the drawer open command process in the event that the process execution flag has been cleared. The S44 and S45 steps may be executed by the flag clearing unit 114. The S44 and S45 steps may be skipped when the drawer 8 is surely expected into the open state in response to the drawer open signal.

FIG. 7 is a flowchart of the drawer status notifying process shown in FIG. 4.

First, the drawer control apparatus 1 may determine whether the latest drawer connection status information stored in the drawer state storing unit 17 represents the presence of connection (Step S71). In the event that the drawer connection status information represents the absence of connection (NO in S71), the drawer control apparatus 1 may transmit data indicative of absence of connection to the host terminal 9 (S72) and then terminate the drawer status notifying process. The presence or absence of connection may be represented by 1-bit data as shown in Table 1. The state information transmitting unit 16 may transmit the bit data “0” (bit 1=0) representing the absence of connection.

TABLE 1

| Bit 1 | Status |
|---|---|
| 0 | Absence of connection |
| 1 | Presence of connection |

In the event that the drawer connection status information represents the presence of connection (YES in S71), the drawer control apparatus 1 may determine whether the latest drawer open/closed status information stored in the drawer state storing unit 17 represents the drawer open state (Step S73). In the event that the latest drawer open/closed status information represents the drawer closed state (NO in S73), the drawer control apparatus 1 may transmit data indicative of the presence of the drawer 8 and indicative of the drawer closed state, and then terminate the drawer status notifying process. The drawer closed state may be represented by 2-bit data as shown in Table 2 separately from the data indicative of the presence or absence of connection. The 2-bit data may include information about the trigger for the drawer open state. The state information transmitting unit 16 may transmit the bit data “1” (bit 1=1) representing the presence of connection and separately transmit the bit data “00” (bit 1=0, bit 2=0) representing the drawer closed state. The drawer control apparatus 1 may execute an initialization at power on. The initialization may finish upon receiving the status inquiry command. The drawer control apparatus 1 may execute the first drawer state information acquiring process and then the drawer status notifying process. The drawer control apparatus 1 can thereby notify the host terminal 9 of correct information about the status of the drawer 8. The drawer control apparatus 1 may transmit information indicative of initialization in response to the status inquiry command received during initialization and send a particular status information stored in the non-volatile memory 102 to the host terminal 9.

TABLE 2

| Bit 2 | Bit 1 | Status |
|---|---|---|
| 0 | 0 | Drawer closed |
| 1 | 1 | Drawer open by command |
| 1 | 0 | (non-use) |
| 0 | 1 | Drawer open by means other than command |

In the event that the latest drawer open/closed status information represents the drawer open state (YES in S73), the drawer control apparatus 1 may discriminate whether the latest open trigger status information stored in the drawer state storing unit 17 represents that the drawer 8 is opened by the drawer open command process or otherwise (Step S75). In the event that the latest open trigger status information represents means other than the drawer open command process (NO in S75), the drawer control apparatus 1 may transmit data indicative of the drawer open state triggered by means other than the drawer open command process (Step S76), and then terminate the drawer status notifying process. The state information transmitting unit 16 may transmit the bit data “1” (bit 1=1) representing the presence of connection and separately transmit the bit data “10” (bit 1=1, bit 2=0) representing the drawer open state triggered by means other than the drawer open command process.

In the event that the latest open trigger status information represents the drawer open command process (YES in S75), the drawer control apparatus 1 may transmit data indicative of the drawer open state triggered by the drawer open command process (Step S77), and then terminate the drawer status notifying process. The state information transmitting unit 16 may transmit the bit data “1” (bit 1=1) representing the presence of connection and separately transmit the bit data “11” (bit 1=1, bit 2=1) representing the drawer open state triggered by the drawer open command process.

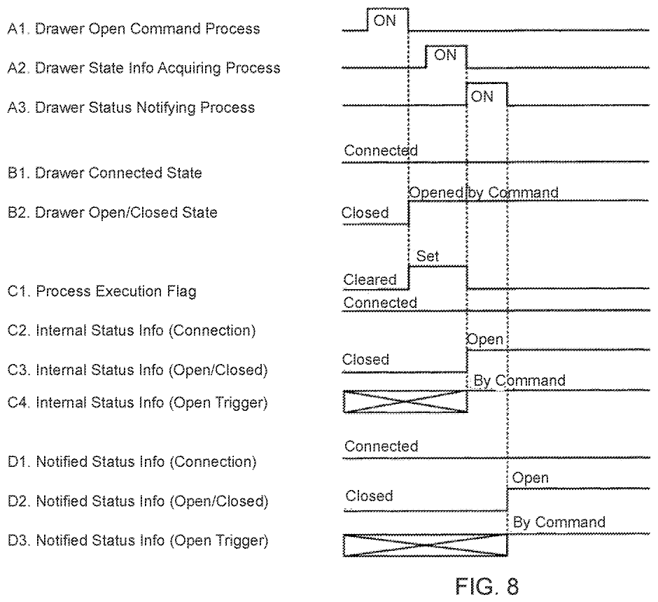

The operation of the drawer control apparatus 1 is being described referring to timing charts. FIG. 8 is a timing chart showing the normal operation of the drawer control apparatus shown in FIG. 1. In FIG. 8, “A” denotes the operations of the drawer control apparatus 1, “B” denotes the state of the drawer 8, “C” denotes the status information stored in the volatile memory 103, and “D” denotes the drawer status information notified to the host terminal 9.

The drawer control apparatus 1 may execute the drawer open command process (Al) upon receiving the drawer open command when the drawer 8 is in the connected state (B1). The drawer 8 may be brought into the open state (B2) and the process execution flag may be set (C1). The drawer control apparatus 1 may then periodically execute the drawer state information acquiring process (A2). The information indicative of the drawer open state may be stored in the drawer state storing unit 17 as the drawer open/closed status information (C3). The open trigger information indicative of the drawer open command process may be stored in the drawer state storing unit 17 as the drawer open trigger status information (C4). The process execution flag may be then cleared (C1). The state monitoring unit 112 may detect a change in the open/closed status information and the drawer control apparatus 1 may then execute the drawer status notifying process (A3), thereby transmitting information to the host terminal 9 indicative of the presence of drawer connection and indicative of the drawer open state triggered by the drawer open command process. The host terminal 9 may be thereby notified that the drawer 8 is in the connected state (D1), that the drawer 8 is in the open state (D2), and that the open state was triggered by the drawer open command process (D3).

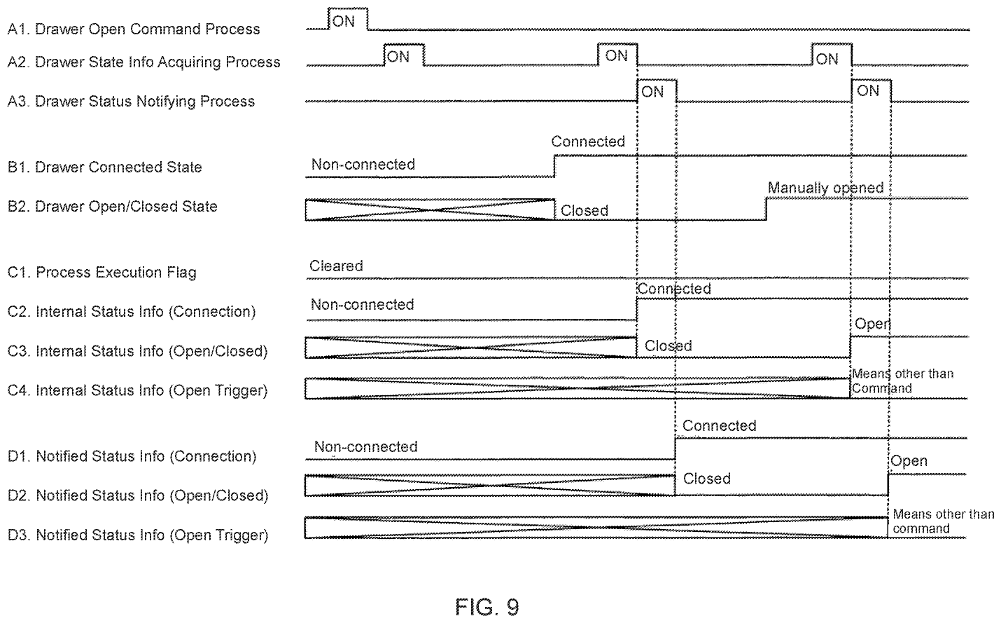

FIG. 9 is a timing chart showing the operations of the drawer control apparatus shown in FIG. 1 before and after the drawer is connected. Use of the symbols (“A” to “D”) is similar to FIG. 8

The drawer control apparatus 1 may start the drawer open command process (A1) upon receiving the drawer open command when the drawer 8 is in the non-connected state (B1). The drawer control apparatus 1 may, however, terminate the process without setting the process execution flag since the drawer 8 is not connected. The drawer control apparatus 1 may then start the drawer state information acquiring process (A2). At the first process, the information indicative of the absence of connection may be stored in the drawer state storing unit 17 as the drawer connection status information (C2). The drawer control apparatus 1 may then terminate the drawer state information acquiring process. The process execution flag may be kept cleared (C1).

When the drawer 8 in the closed state is connected (B1), the drawer control apparatus 1 may execute the drawer state information acquiring process (A2). The information indicative of the presence of connection may be stored in the drawer state storing unit 17 as the drawer connection status information (C2). The information indicative of the drawer closed state may be stored in the drawer state storing unit 17 as the drawer open/closed status information (C3). The state monitoring unit 112 may detect a change in the drawer connection status information and the drawer control apparatus 1 may then execute the drawer status notifying process (A3). The information indicative of the presence of drawer connection and the information indicative of the drawer closed state may be transmitted to the host terminal 9. The host terminal 9 may be thereby notified that the drawer 8 is in the connected state (D1) and that the drawer 8 is in the closed state (D2).

When the drawer 8 is manually opened, the drawer control apparatus 1 may execute the drawer state information acquiring process (A2). The information indicative of the drawer open state may be stored in the drawer state storing unit 17 as the drawer open/closed status information (C3). The information indicative of the open trigger means other than the drawer open command process may be stored in the drawer state storing unit 17 as the drawer open trigger status information (C4). The state monitoring unit 112 may detect a change in the drawer open/closed status information and the drawer control apparatus 1 may then execute the drawer status notifying process (A3). The information indicative of the presence of drawer connection and the information indicative of the open trigger means other than the drawer open command process may be transmitted to the host terminal 9. The host terminal 9 may be thereby notified that the drawer 8 is in the connection state (D1), that the drawer 8 is in the open state (D2), and that the open state was caused by means other than the drawer open command process (D3).

The drawer control apparatus 1 of this embodiment can start the drawer open command process in response to the drawer open command and immediately terminate the process without setting the process execution flag when the drawer 8 is not connected. The drawer control apparatus can correctly discriminate whether the drawer open state was triggered by the drawer open command process or otherwise even when the drawer in the closed state is connected after the start of the drawer open command process, and then the drawer is opened. The flag clearing unit 114 can clear the process execution flag when, for example, the money tray is pushed backward or the drawer remains closed due to a structural defect. When the drawer 8 is opened by means other than the drawer open command process while the process execution flag kept cleared, the drawer control apparatus 1 can correctly discriminate that the drawer open state is caused by means other than the drawer open command process. The host terminal 9 can acquire the drawer connection status information, the drawer open/closed status information, and the open trigger status information to analyze the state of the drawer 8 in detail, which facilitating recognition of any abnormal act occurrence. The drawer control apparatus 1 can execute the drawer status notifying process when the state monitoring unit 112 detects a change in the drawer connection status information or the drawer open/closed status information. The host terminal can therefore immediately and correctly recognize the change in the state of the drawer 8. The drawer control apparatus 1 can use 2-bit data to notify the host terminal 9 of the drawer open/closed state (Bit 1) and the open trigger (Bit 2). The host terminal 9 can selectively refer to Bit 1 to recognize the open/closed state regardless of the trigger (Bit 2). Any host terminal only responsible to Bit 1 needs no modification to recognize the drawer open/closed state. Furthermore, the drawer control apparatus 1 can execute the drawer status notifying process when the drawer 8 is connected, which allows the host terminal 9 to discriminate whether the drawer in the open state is connected or the drawer in the closed state is connected.

The drawer control apparatus 1 of a second embodiment is being described. Any element having the same name as that in the first embodiment will have the same symbol and overlapping descriptions will be omitted. In the second embodiment, the host terminal 9 can be notified of the drawer open/closed status information and the open trigger status information even if the drawer connection information is not available.

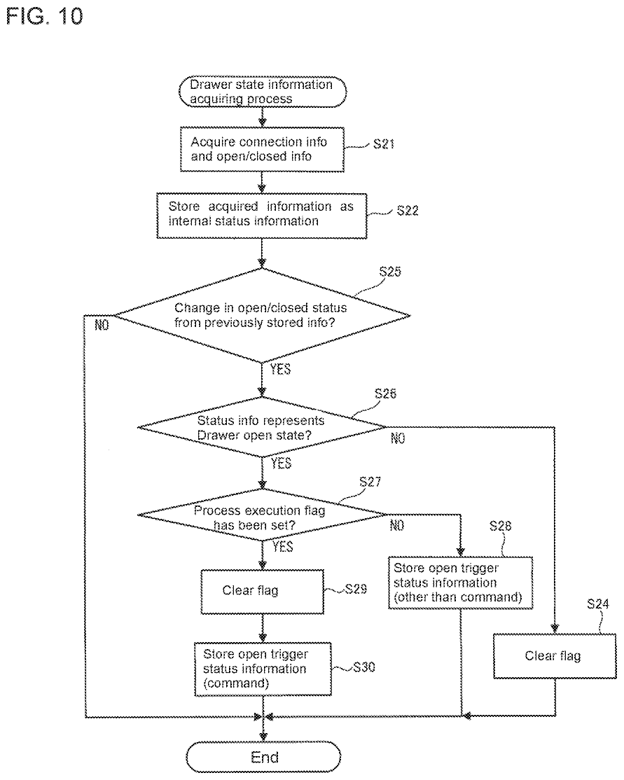

FIG. 10 is a flowchart of the drawer state information acquiring process in the second embodiment. FIG. 10 is the same as FIG. 5 except that Step S23 in FIG. 5 is skipped.

The drawer control apparatus 1 can execute Step S25 and subsequent steps even when the drawer connection detection fails or when the detection does not function. The drawer control apparatus 1 can thereby discriminate whether the drawer open state was triggered by the drawer open command process or otherwise even when the drawer connection detection fails or the detection does not function.

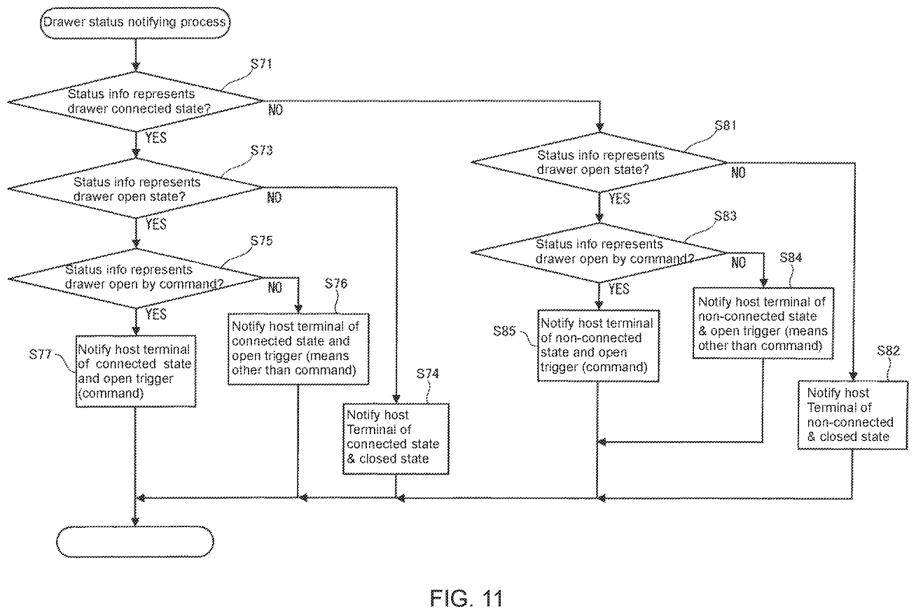

FIG. 11 is a flowchart of the drawer status notifying process in the second embodiment. FIG. 11 is the same as FIG. 7 except that Step S72 in FIG. 7 is replaced by Steps S81 to S85.

In the event that the drawer connection status information represents the absence of connection (NO in S71), the drawer control apparatus 1 may determine whether the latest drawer open/closed status information stored in the drawer state storing unit 17 represents the drawer open state (Step S81). In the event that the drawer open/closed status information represents the drawer closed state (NO in S81), the drawer control apparatus 1 may transmit data indicative of the absence of the drawer 8 and data indicative of the drawer closed state (Step S82) to the host terminal 9, and then terminate the drawer status notifying process. Specifically, the state information transmitting unit 16 may transmit the bit data “0” (bit 1=0) (see Table 1) and separately transmit the bit data “00” (bit 1=0, bit 2=0) (see Table 2).

In the event that the drawer open/closed status information stored in the drawer state storing unit 17 represents the drawer open state (YES in S81), the drawer control apparatus 1 may determine whether the latest open trigger status information stored in the drawer state storing unit 17 represents the drawer open command process (Step S83). In the event that the drawer open trigger status information represents means other than the drawer open command process (NO in S83), the drawer control apparatus 1 may transmit data indicative of the absence of the drawer 8 and data indicative of the drawer open state triggered by means other than the drawer open command process (Step S84), and then terminate the drawer status notifying process. Specifically, the state information transmitting unit 16 may transmit the bit data “0” (bit 1=0) (see Table 1) and separately transmit the bit data “10” (bit 1=1, bit 2=0) (see Table 2).

In the event that the drawer open trigger status information represents the drawer open command process (YES in S83), the drawer control apparatus 1 may transmit data indicative of the absence of the drawer 8 and data indicative of the drawer open state triggered by the drawer open command process (Step S85), and then terminate the drawer status notifying process. Specifically, the state information transmitting unit 16 may transmit the bit data “0” (bit 1=0) (see Table 1) and separately transmit the bit data “11” (bit 1=1, bit 2=1) (see Table 2).

In the second embodiment, the host terminal 9 can be notified of the open/closed status information and the open trigger status information even if the presence/absence of drawer connection information is not available. The open trigger information (Table 2), however, may be unnecessary when the drawer 8 is in the non-connected state and the connection detection normally functions.

The drawer control apparatus 1 of a third embodiment is being described. The open/closed detecting switch 82 of the drawer 8 may transmit a signal of High level upon detecting the drawer open state and a signal of Low level upon detecting the drawer closed state. On the contrary, the open/closed detecting switch 82 may transmit a signal of Low level upon detecting the drawer open state and a signal of High level upon detecting the drawer closed state. In the third embodiment, none of the non-volatile memory 102 or the volatile memory 103 may store a correspondence table between the open/closed states of the drawer 8 and the signal levels received by the open/closed signal receiving unit 15. The drawer control apparatus 1 cannot understand the meaning of the open/closed signal.

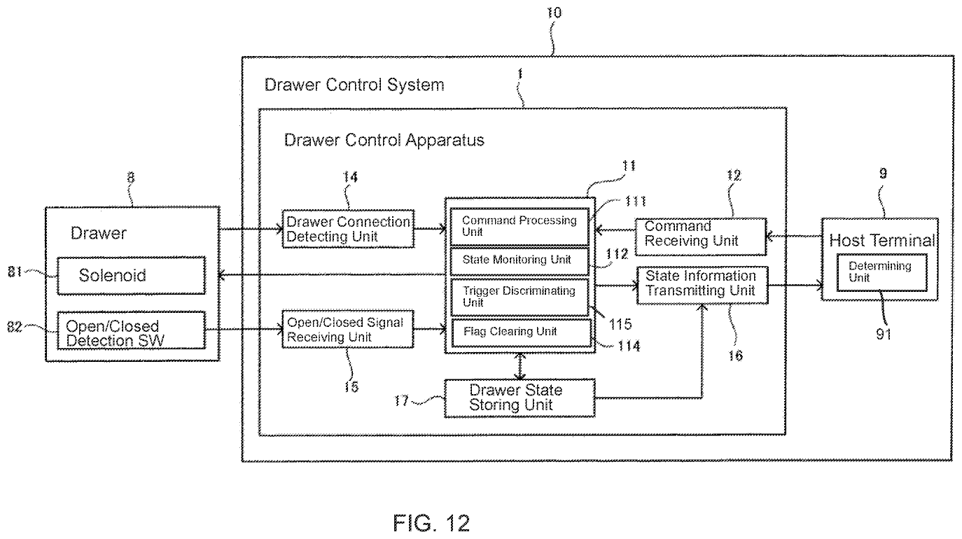

FIG. 12 is a functional block diagram of the third embodiment. FIG. 12 is the same as FIG. 2 except that the open trigger discriminating unit 113 in FIG. 2 is replaced by a trigger discriminating unit 115 and that the host terminal 9 is provided with a discriminating unit 91.

The drawer control apparatus 1 of the third embodiment cannot recognize the open/closed states of the drawer 8 because of having no correspondence table between the open/closed states of the drawer 8 and the signal levels received by the open/closed signal receiving unit 15. When the signal received by the open/closed signal receiving unit 15 represents a change in the open/closed state, the trigger discriminating unit 115 may discriminate whether the change is caused by the drawer open command or otherwise according to a set state of the process execution flag. Specifically, when the signal level switches between the High level and the Low level, the trigger discriminating unit 115 may discriminate whether the change is caused by the drawer open command process or otherwise regardless of the open/closed state of the drawer 8. The host terminal 9 may be provided with a not-shown memory and a not-shown CPU. The discriminating unit 91 of the host terminal 9 may execute a program referring to the memory storing a corresponding table between the signal levels and the drawer open/closed states. The discriminating unit 91 may discriminate whether the drawer is opened by the drawer open command process or otherwise according to the table, the information from the trigger discriminating unit 115, and the signal level information.

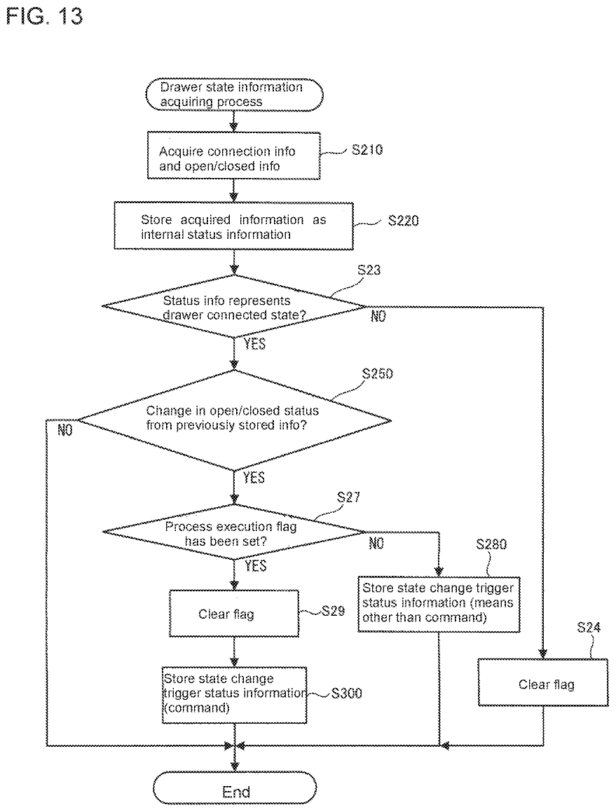

FIG. 13 is a flowchart of the drawer state information acquiring process in the third embodiment. FIG. 13 is similar to FIG. 5.

The drawer connection detecting unit 14 may detect the absence/presence of drawer connection to acquire the drawer connection information. The drawer open/closed signal receiving unit 15 may receive the open/closed signal to acquire information indicative of the signal level of the open/closed signal (Step S210). Information indicative of the signal level of the open/closed signal may be referred to as an open/closed signal information. The Step S210 may correspond to an example of a drawer open signal receiving step. The drawer control apparatus 1 may store the just acquired drawer connection information and the open/closed signal information in the drawer state storing unit 17 as a present internal status information (Step S220). The drawer control apparatus 1 may still keep the previous internal status information stored including the drawer connection information, the open/closed signal information and the state change trigger information (described below).

The drawer control apparatus 1 may compare the present internal status information with the previous internal status information to determine whether a change occurs (Step S250). The drawer control apparatus 1 may determine that a change occurs when the drawer state storing unit 17 stores no previous information, for example, at the first drawer state information acquiring process after power on. In the event that the drawer open/closed signal information represents no change (NO in S250) or the signal level does not switch between High and Low, the drawer control apparatus 1 may terminate the drawer state information acquiring process. In the event that the open/closed signal information represents a change (YES in S250) or the signal level switches between High and Low, the drawer control apparatus 1 may skip S26 (in FIG. 5) and execute Step S27.

In the event that the process execution flag has been cleared (NO in S27), the drawer control apparatus 1 may store the state change trigger information indicative of means other than the drawer open command process in the drawer state storing unit 17 as a present internal status information (Step S280) and then terminate the drawer state information acquiring process. The state change trigger information indicative of means other than the drawer open command process may be referred to as a non-command open/closed state change information. In the event that the process execution flag has been set (YES in S27), the drawer control apparatus 1 may clear the flag (Step S29). The drawer control apparatus 1 may then store the state change trigger information indicative of the drawer open command process as a present internal status information (Step S300) and then terminate the drawer state information acquiring process. The state change trigger information indicative of the drawer open command process may be referred to as a command open/closed state change information. The S27, S280, S29, and S300 steps corresponding to the trigger discriminating step may be executed by the trigger discriminating unit 115. The drawer of this embodiment cannot be structurally closed by a command. Therefore, in the event that the process execution flag has been set (YES in S27), the drawer control apparatus 1 can determine that a change in the drawer occurs by the drawer open command process and the drawer is opened. The trigger discriminating unit 115 may function as the open trigger discriminating unit since it can discriminate whether the open trigger is the drawer open command process or otherwise.

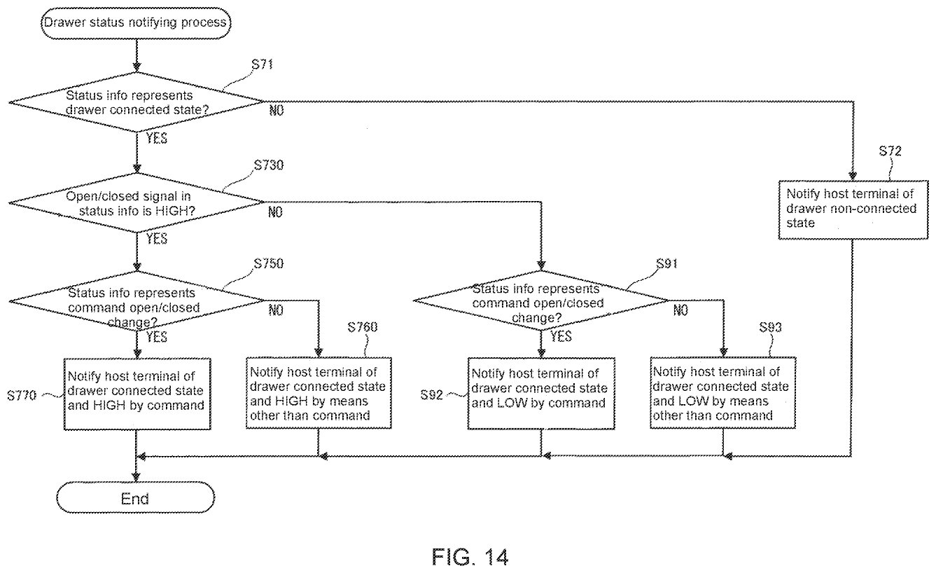

FIG. 14 is a flowchart of the drawer status notifying process in the third embodiment. FIG. 11 is similar to FIG. 7.

In the event that the drawer connection status information represents the presence of connection (YES in S71), the drawer control apparatus 1 may determine whether the latest open/closed signal status information stored in the drawer state storing unit 17 represents High level (Step S730). In the event that the latest open/closed signal status information does not represent High level (NO in S730), the drawer control apparatus 1 may determine whether the latest state change trigger information stored as the internal status information represents the command open/closed change information (Step S91). In the event that the latest state change trigger status information does not represent the command open/closed change information or the latest state change trigger status information represents the non-command open/closed change information (NO in S91), the drawer control apparatus 1 may transmit information indicative of presence of the drawer 8 and information indicative of Low level by non-command open/closed state change (S93) and then terminate the drawer status notifying process. The information indicative of Low level by non-command open/closed state change may be represented by 2-bit data as shown in Table 3 separately from the data indicative of the presence or absence of connection. The state information transmitting unit 16 may transmit bit data “1” (bit 1=1) representing the presence of connection and separately transmit bit data “00” (bit 1=0, bit 2=0) representing the Low level by non-command open/closed state change. Table 3 may be an example of information indicative of discriminating result by the trigger discriminating unit 115 and indicative of signal level of the open/closed signal. Bit 1 represents High or Low while Bit 2 represents command or otherwise. The host terminal 9 may selectively acquire only one of the Bits as required.

TABLE 3

| Bit 2 | Bit 1 | Status |
|---|---|---|
| 0 | 0 | Low by means other than command |
| 1 | 1 | High by command |
| 1 | 0 | Low by command |
| 0 | 1 | High by means other than command |

In the event that the latest state change trigger status information represents the command open/closed change information (YES in S91), the drawer control apparatus 1 may transmit information indicative of presence of the drawer 8 and information indicative of Low level by command open/closed state change (S92) and then terminate the drawer status notifying process. The state information transmitting unit 16 may transmit bit data “1” (bit 1=1) representing the presence of connection and separately transmit bit data “01” (bit 1=0, bit 2=1) representing the Low level by command open/closed state change.

In the event that the latest open/closed signal status information represents High level (YES in S730), the drawer control apparatus 1 may determine whether the latest state change trigger information stored as the internal status information represents the command open/closed change information (Step S750). In the event that the latest state change trigger status information does not represent the command open/closed change information or the latest state change trigger status information represents the non-command open/closed change information (NO in S750), the drawer control apparatus 1 may transmit information indicative of presence of the drawer 8 and information indicative of High level by non-command open/closed state change (S760) and then terminate the drawer status notifying process. The state information transmitting unit 16 may transmit bit data “1” (bit 1=1) representing the presence of connection and separately transmit bit data “10” (bit 1=1, bit 2=0) representing the High level by non-command open/closed state change.

In the event that the latest state change trigger status information represents the command open/closed change information (YES in S750), the drawer control apparatus 1 may transmit information indicative of presence of the drawer 8 and information indicative of High level by command open/closed state change (S770) and then terminate the drawer status notifying process. The state information transmitting unit 16 may transmit bit data “1” (bit 1=1) representing the presence of connection and separately transmit bit data “11” (bit 1=1, bit 2=1) representing the High level by command open/closed state change. The S92, S93, S760, and S770 steps may correspond to a state information transmitting step. The drawer of this embodiment cannot be structurally closed by a command. One of the S92 and S770 steps representing that the drawer is closed by command may not be used.

The discriminating unit 91 (FIG. 12) of the host terminal 9 may acquire status information of the drawer 8 from the state information transmitting unit 16 of the drawer control apparatus 1. The discriminating unit 91 may also acquire the correspondence table stored in the not-shown memory of the host terminal 9, the table showing relations between the signal levels of the open/closed signal and the open/closed states. The discriminating unit 91 may thereby discriminate whether the drawer is opened and whether the drawer is opened by the drawer open command process, which may correspond to a discriminating step. A discrimination result may be stored in the memory of the host terminal 9.

The drawer control system 10 of the third embodiment may have the same effects as in the other embodiments and further enhance versatility of the drawer control apparatus 1 regardless of difference of the signal levels of the open/closed detection switch 82 depending on the drawer.

The invention may not be limited to the embodiments described above and may be variably embodied within the scope of the claims. For example, the drawer control apparatus 1 may be separately provided from the drawer 8 or may be integrated with the drawer 8. The drawer control apparatus 1 may be incorporated in another peripheral device such as a printer or may be incorporated in the host terminal 9.

The elements disclosed in any of the embodiments may be applied in the other embodiments.

1. A drawer control apparatus comprising:
a command receiving unit capable of receiving a command from a host terminal;
a drawer connection detecting unit capable of detecting presence or absence of connection of a drawer;
a command processing unit capable of executing a drawer open command process when the command receiving unit receives a drawer open command, the drawer open command process comprising sending a drawer open signal and setting a process execution flag when the drawer connection detecting unit detects the presence of connection of the drawer, and the drawer open command process further comprising terminating the drawer open command process when the drawer connection detecting unit detects the absence of connection of the drawer;
a drawer open/closed signal receiving unit capable of receiving a drawer open/closed signal from the drawer, the signal representing a drawer open state or a drawer closed state; and
an open trigger discriminating unit capable of discriminating whether the drawer open state is triggered by the drawer open command process or otherwise according to a set state of the process execution flag when the drawer open/closed signal receiving unit receives the signal representing the drawer open state.

2. The drawer control apparatus of claim 1 further comprising a flag clearing unit capable of clearing the process execution flag after predetermined time elapses since the flag was set.

3. The drawer control apparatus of claim 1 further comprising a state information transmitting unit capable of transmitting drawer connection information to the host terminal, the drawer connection information representing the presence or absence of connection of the drawer.

4. The drawer control apparatus of claim 2 further comprising a state information transmitting unit capable of transmitting drawer connection information to the host terminal, the drawer connection information representing the presence or absence of connection of the drawer.

5. The drawer control apparatus of claim 3, wherein the state information transmitting unit further transmits drawer open/closed information and open trigger information to the host terminal, the drawer open/closed information representing the drawer open state or the drawer closed state and the open trigger information representing a discrimination result of the open trigger discriminating unit.

6. The drawer control apparatus of claim 4, wherein the state information transmitting unit further transmits drawer open/closed information and open trigger information to the host terminal, the drawer open/closed information representing the drawer open state or the drawer closed state and the open trigger information representing a discrimination result of the open trigger discriminating unit.

7. The drawer control apparatus of claim 1 further comprising a drawer state storing unit capable of storing drawer connection information representing the presence or absence of connection of the drawer, drawer open/closed information representing the drawer open state or the drawer closed state, and open trigger information representing a discrimination result of the open trigger discriminating unit;
a state monitoring unit capable of monitoring a change in the drawer connection information and a change in the drawer open/closed information; and
a state information transmitting unit capable of transmitting the drawer connection information, the drawer open/closed information, and the open trigger information stored in the drawer state storing unit to the host terminal when the state monitoring unit detects a change in at least one of the drawer connection information and the drawer open/closed information.

8. The drawer control apparatus of claim 2 further comprising a drawer state storing unit capable of storing drawer connection information representing the presence or absence of connection of the drawer, drawer open/closed information representing the drawer open state or the drawer closed state, and open trigger information representing a discrimination result of the open trigger discriminating unit;
a state monitoring unit capable of monitoring a change in the drawer connection information and a change in the drawer open/closed information; and
a state information transmitting unit capable of transmitting the drawer connection information, the drawer open/closed information, and the open trigger information stored in the drawer state storing unit to the host terminal when the state monitoring unit detects a change in at least one of the drawer connection information and the drawer open/closed information.

9. A drawer control apparatus comprising:
a command receiving unit capable of receiving a drawer open command from a host terminal, the drawer open command instructing an open of a drawer;
a drawer connection detecting unit capable of detecting presence or absence of connection of the drawer;
a drawer open/closed signal receiving unit capable of receiving a drawer open/closed signal from the drawer, the signal representing a drawer open state or a drawer closed state; and
a state information transmitting unit capable of transmitting drawer connection information and drawer open/closed information to the host terminal, the drawer connection information representing the presence or absence of connection of the drawer and the drawer open/closed information representing the drawer open state or the drawer closed state.

10. A drawer control method comprising:
receiving a command from a host terminal;
detecting presence or absence of connection of a drawer;
executing a drawer open command process upon receiving a drawer open command, the drawer open command process comprising sending a drawer open signal and setting a process execution flag upon detecting the presence of connection of the drawer, and the drawer open command process further comprising terminating the drawer open command process upon detecting the absence of connection of the drawer;
receiving a signal from the drawer, the signal representing a drawer open state or a drawer closed state; and
discriminating whether the drawer open state is triggered by the drawer open command process or otherwise according to a set state of the process execution flag upon receiving the signal representing the drawer open state.

11. A drawer control system comprising a host terminal and a drawer control apparatus:
the drawer control apparatus comprising:
a command receiving unit capable of receiving a command from a host terminal;
a drawer connection detecting unit capable of detecting presence or absence of connection of a drawer;
a command processing unit capable of executing a drawer open command process when the command receiving unit receives a drawer open command, the drawer open command process comprising sending a drawer open signal and setting a process execution flag when the drawer connection detecting unit detects the presence of connection of the drawer, and the drawer open command process further comprising terminating the drawer open command process when the drawer connection detecting unit detects the absence of connection of the drawer;
a drawer open/closed signal receiving unit capable of receiving a drawer open/closed signal from the drawer, the signal representing a drawer open state or a drawer closed state by a signal level;
a trigger discriminating unit capable of discriminating whether a change in the drawer open state and the drawer closed state is triggered by the drawer open command process or otherwise according to a set state of the process execution flag when the signal received by the drawer open/closed signal receiving unit represents the change in the drawer open state and the drawer closed state; and
a state information transmitting unit capable of transmitting information to the host terminal, the information comprising information representing a discrimination result by the trigger discriminating unit and information representing the signal level; and
the host terminal comprising:
a discriminating unit capable of discriminating whether the drawer open state is triggered by the drawer open command process or otherwise according to the information transmitted from the state information transmitting unit.
